(19) United States
(12) Patent Application Publication
(10) Pub. No.: US 2005/0000296 A1
(43) Pub. Date: Jan. 6, 2005

(54) Fastening arrangement for a sensor at a receptacle

(76) Inventors: Thomas Kopp, Wolfach (DE); Hermann Dieterle, Wolfach (DE)

Correspondence Address: NATH & ASSOCIATES, 1030 15th STREET, NW, 6TH FLOOR, WASHINGTON, DC, 20005, US

(21) Appl. No.: 10/831,334

(22) Filed: Apr. 22, 2004

(30) Foreign Application Priority Data
Apr. 24, 2003 (DE) 10318679.4

(51) Int. Cl. G01L 7/00

(52) U.S. Cl. 73/756

(57) ABSTRACT

The invention relates to a fastening arrangement for a sensor (2) on a receptacle (1), with a receptacle through-hole (13, 13a) leading to the interior (12) of the receptacle (1), a receptacle stop (16), and a sensor housing (20-23) exhibiting a sensor device (28) and a circumferential housing stop (27). To advantageously fasten the sensor to the receptacle a pressure screw (4) is provided, which exhibits a pressure screw through-hole (41), which receives the housing (20, 23); and exhibits a pressure area (43) used in pressing the housing stop (27) against the receptacle stop (16) to fasten together the sensor housing (20, 23) and the receptacle (1).

The invention relates to a fastening arrangement for a sensor on a receptacle, with the features specified in the preamble of claim 1.

Used as measuring devices, e.g. in the so-called headbox nozzle employed in the paper-manufacturing industry, are pressure sensors, by means of which paper thickness is controlled in the process of manufacturing paper.

There are generally known fastening arrangements for a sensor device on a receptacle which take the form of a mating flange on an projecting tube belonging to a receptacle. To secure the flange, a sensor housing, which receives the sensor device, exhibits a flange, which is positioned in circular fashion around the tube by means of a plurality of screws. The number of screws is determined by the required pressure load. For the purposes of the paper industry a nominal dimension of DN25 with an outer diameter of 115 mm is customary. The hole for the mating flange is designed accordingly.

This kind of arrangement exhibits various disadvantages, however. For example, the pressure-measuring device cannot be positioned properly when the connection space has small dimensions. For the purposes of design this requires that the connection space have a minimum limit. In addition, the fastening screws of the flange attachment are poorly accessible when the attachment space is small. Since too little space may be available the flange is often flattened on both side, thereby reducing its resistance to pressure.

The goal of the invention is permit a simpler installation and make possible a hole with a smaller diameter.

This goal is achieved in a fastening arrangement for a sensor on a receptacle with the features of patent claim 1.

A preferred fastening arrangement for a sensor on a receptacle exhibits a receptacle through-hole running from a receptacle outside surface to the receptacle interior, and a sensor housing containing the sensor device and a circumferential housing stop; the arrangement includes a screw connecting element for fastening the sensor housing in the area of the receptacle through-hole. The sensor housing itself is guided through a pressure screw through-hole, and the sensor housing stop is secured between a front-end pressure area on the pressure screw and a counter-stop in the area of the receptacle through-hole. For the purpose of fastening, the pressure screw exhibits an outer thread, which engages with a matching inner thread in the area of the receptacle through-hole.

Advandageous embodiments are the subject matter of the dependent claims.

An exemplary embodiment is next explained in detail on the basis of the drawing, which depicts:

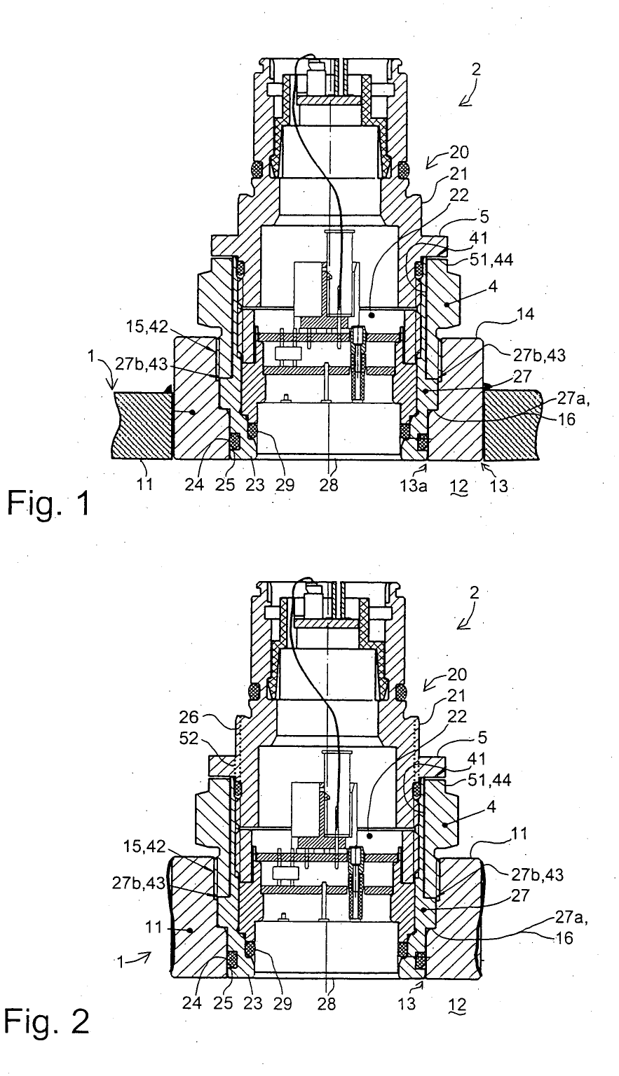

FIG. 1 a fastening arrangement for a pressure sensor whose housing is secured to a receptacle through-hole

FIG. 2 an alternative embodiment.

As shown in FIG. 1, a preferred fastening arrangement exhibits a plurality of individual components. Secured to a receptacle 1 is a sensor, which in the depicted embodiment is a pressure sensor 2 and which can again be detached.

The receptacle 1 exhibits a wall 11 between a receptacle interior 12 and the outside of the receptacle 1. A receptacle through-hole 13 runs through the wall 11 from the outside to the receptacle interior 12. A bushing is secured on, or (in the depicted example) in, the receptacle through-hole 13; in the depicted example it is a welded-in bushing. In its through-hole 13a, which runs from the receptacle interior 12 to the outside of the receptacle 1, the bushing exhibits an inner thread 15 on its inside, in the section that points outward. The inner diameter of the bushing through-hole 13a diminishes in the direction of the inside of the receptacle 1; in the preferred embodiment it diminishes in stages, so that a receptacle stop 16 is formed in the bushing through-hole 13a.

The sensor 2 exhibits a housing 20, which in the depicted exemplary embodiment is composed of an outside housing part 21 and an inside housing part 22. Outside and inside are understood here in terms of direction relative to the inside 12 and outside of the receptacle and serve merely to more graphically describe the orientation of the components relative to one another. The outside housing part 21 chiefly serves to receive electronic components, while the actual sensor components, such as the sensor cell 28, will preferably be positioned in the inside housing part 22. This permits the sensor to have a more modular design. The outside housing part 21 and the inside housing part 22 are held together by a housing connecting device 23, which encompasses both parts. At the same time, the housing connecting device 23 shown in the exemplary embodiment is the housing section that interacts with the largest number of components in the fastening arrangement. In simpler exemplary embodiments a sensor with a single-part housing can be advantageously employed instead of the arrangement featuring a sensor 2 with several housing parts 21-23. In the following, therefore, the relevant components are presented as components of the housing 20, although the components in the depicted exemplary embodiment predominately belong to the housing connecting device 23.

The outside or, as the case may be, inside section of the depicted housing 20, 23 referred to in the description has an outer circumference which corresponds to the inner circumference of the segment of the bushing through-hole 13a facing the receptacle interior 12. This permits the housing 20, 23 to be exactly fitted, within the usual tolerances, into the bushing through-hole 13a. For the purpose of sealing, the housing has a circumferential groove 25 to receive a seal 24, ideally an O-ring. To permit the housing 20, 23 to be inserted simply, and in a manner that spares the seal, into the bushing through-hole 13a, the outside edge of this section of the bushing through-hole 13a—in the present example, the edge of the receptacle stop 16—is rounded off, i.e., is formed without a sharp edge.

To limit the insertion depth of the housing 20, 23 into the bushing 14 to the desired degree the housing 20, 23 has a circumferential housing stop 27. The outer circumference of the housing stop 27 will ideally correspond to the inner circumference, or inner diameter, of the bushing through-hole 13a in the latter's outside section, i.e., in the present case, the section outside the receptacle stop 16. As a result, the housing 20 can only be inserted into the bushing 14 up to a point such that the inside housing stop area 27a of the housing stop 27 comes up against the outside stop area of the receptacle stop 16.

Serving to secure the housing 20 to the receptacle 1, or the bushing 14, is a pressure screw 4, which exhibits a central through-hole 41 with which it encompasses the housing 20, 23. The inside-directed section (i.e., pointing toward the receptacle 1) of the pressure screw 4 has an outer diameter which is fitted to the inner diameter of the outwardly directed inside section of the bushing through-hole 13a. In this section the pressure screw 4 also has an external thread 42, which engages upon assembly with the inner thread 15 of the bushing through-hole 13a. When screwed into the bushing the pressure screw 4 moves in the direction of the receptacle interior 12 and in the direction of the housing stop 27 of the inserted housing 20. The housing stop 27 exhibits an outside housing stop area 27b, which ideally will have a width that corresponds to the wall thickness of the pressure screw. In assembled position the face of the pressure screw, in the form of pressure screw stop 43, presses housing stop 27 against the receptacle stop 16 and thereby fastens the housing 20, 23 firmly to the receptacle 1, or bushing 14.

FIG. 2 shows a simpler embodiment with a corresponding receptacle wall thickness 11; in this alternative the receptacle through-hole 13 is provided directly with a receptacle stop and an inner thread for receiving the housing 20, 23 and the pressure screw 4, thereby allowing the bushing 14 to be omitted.

The outside section of the pressure screw 4 in FIGS. 1 and 2 will preferably be formed in such a way that it can be grasped manually or with a screwing tool, even when its dimensions are small and/or when the outside access area is of limited size.

To seal an actual sensor element or a sensor cell 28 exhibiting a pressure absorber in the front area of the sensor housing 20, 23, another seal is provided, particularly in the form of an O-ring, between the inner wall of the housing 20, 23 and the outer circumference of the sensor cell 28.

In the choice of fastening arrangement, this kind of configuration permits a receptacle hole 13, as the container attachment point, that exhibits a smaller diameter than in previous arrangements, since the sensor—in the present case a pressure measuring device—is attached with a pressure screw 4, which in the preferred embodiment is centrally positioned around the sensor 2 and can rotate. Here the pressure screw 4 can be provided, e.g., with an outer thread 42 that is customary in the paper industry, so that a pressure sensor 2 with a small outer diameter is permitted, for example, 30 mm or less as the outer diameter. Thus sensors with housings and/or sensor cells exhibiting outer diameters less than the customary 115 mm are possible in connection with the measurement of pressure in a receptacle, and the outer diameter can not only be smaller, but can also confer the advantage of being significantly smaller than the customary 115 mm. As a pressure sensor of this kind, the sensor cell 28 will ideally be sealed with O-rings 29, 34.

Because the pressure screw 4 rotates around the housing 20, 23 the housing 20, 23 is axially inserted into the receptacle through-hole 13, or the bushing through-hole 13a, using the collar-like housing stop 27. In part because the friction of metal surfaces is lower than that of a sealing material, specifically the O-ring, the latter is less subject to load in a translational movement over a short distance than in a rotational movement for that case in which the entire housing 20, 24 is screwed into the receptacle through-hole, or the bushing through-hole 13a, with a screwing motion.

In the exemplary embodiment depicted in FIG. 1 the outside housing part 21 exhibits another outside stop 5. This stop 5 can take the form of an individual small projection or, as shown, of a circumferential ring. The outside stop serves to hold the pressure screw 4 on the housing 20 so that when the housing 20 is assembled or disassembled the pressure screw 4 does not fall off it and become lost. In this exemplary embodiment the pressure screw 4, which consequently exhibits an outside stop surface 44 as a counter-stop for the outside stop 5 of the housing 20, is secured to the housing 20 when the latter is assembled. It is expedient to do this in such a way that the pressure screw 4 is mounted in rotating fashion around the housing 20. The pressure screw 4 is restricted in is motion toward and away from receptacle 1 by the stops 27, 5. Upon disassembly, in conjunction with the screwing movement, not only is the pressure screw 4 lifted relative to the receptacle 2, but the entire housing is lifted too, with the result that any sticking resistance caused by the seal 24 is overcome with the screwing movement.

FIG. 2 shows an exemplary embodiment in which the pressure screw 4 can additionally be pushed over the housing 20 or, as the case may be, the assembled housing 20. To protect the pressure screw 4 from loss the housing 20, 21 has a circumferential outer thread 26, onto which a corresponding outside housing stop 5 with an inner thread 52 can be screwed. If the outside housing stop 52 is screwed entirely onto the pressure screw 4, the outside housing stop 52 will serve as a counter-stop, as in the exemplary embodiment of FIG. 1, when the sensor 2 is dismounted from the receptacle 1.

The advantageous possibility of an almost force-free disassembly also obtains for the case where no outside housing stop 5 is provided or is in place inasmuch as the pressure screw 4 is holding the tube or, as the case may be, is holding the housing 20, 23 and the pressure screw 4 can be detached independent of any possibly adhering O-ring. In a first step, consequently, the clamping force of the housing stop 27 is released independent of any possible sticking resistance caused by the seal 24, whereupon the housing 20, 23 can be removed from the bushing through-hole 13a in a second step, after a merely residual adhesive friction caused by the seal 24 is overcome.

The use of a pressure screw 4 provides another advantage inasmuch as the housing 20, 24 is not attached to the flange 14 of the receptacle 1 with a customary flange and a number of screws. This distinctly reduces the number of the components which must be handled in a narrow access area during assembly and disassembly, and which run the risk of being lost. It is advantageous that only the pressure screw 4 has be to detached during disassembly but can then be lifted to rest above the housing 20 by means of the housing stop 27, so that ultimately—during assembly and disassembly in a narrow space providing access to the receptacle through-hole 23, or the bushing through-hole 13a—it is necessary to hold only one structural component 20, on which the pressure screw 4 is already loosely sitting.

As can be seen in the drawing the inside and outside housing part 22, 21 can be held together by the housing connecting device 23 using stops and counter-stops or, as the case may be, projections that engage with grooves. Projections that engage with grooves can take the form of a shrink-connection; they may be of a bayonet type or some other known type.

Variations are possible in many different forms. For example, the housing stop 27 can take the form of an annular circumferential stop in one preferred embodiment. In alternative embodiments, however, it is also possible to allow one or several projections to stick out from the outer circumference of the housing 20, 23, such that the projections are pushed against the receptacle stop 16 by the front of the pressure screw. Whereas the depicted housing stop 27 runs in circular fashion around the housing 20, 23 and projects from the housing laterally, it is also possible to provide spaced housing stops in an axial direction, such that the stops facing the receptacle 1 are counter-stops for the receptacle stop 16 and the stops turned away from the receptacle 1 are counter-stops for the front stop area, or the stop 43, of the pressure screw 4.

List of Reference Numbers:

1 receptacle
11 wall of receptacle
12 receptacle interior
13 receptacle through-hole
13a bushing through-hole
14 bushing
15 inner thread in through-hole 13a
16 receptacle stop
2 sensor
20 housing
21 outside housing part
21 inside housing part
22 housing connecting device
24 sealing/O-ring (housing receptacle)
25 groove for seal 24
26 outer thread for outside housing stop
27 housing stop
27b,a outwardly directed/inside housing stop area
28 sensor measuring cell
29 O-ring (sensor cell housing)
4 pressure screw
41 pressure screw through-hole
42 outer thread
43 stop of 4, front
44 stop of 4, outside
5 outside housing stop
51 stop area of 5
52 inner thread of 5

1. A fastening arrangement for a sensor (2) on a receptacle (1) with
a receptacle through-hole (13, 13a) leading to the interior (12) of the receptacle (1) and with a receptacle stop (16), and
a housing (20-23) for the sensor (2), with a sensor device (28) and a circumferential housing stop (27),
wherein
a pressure screw (4) with a pressure screw through-hole (41) encompasses the housing (20, 23) and exhibits a pressure area (43) for pressing the housing stop (27) against the receptacle stop (16) in order to fasten together the sensor housing (20, 23) and the receptacle (1), where the pressure screw (4) engages in screw-like fashion with a thread (13, 13a) of the receptacle (1) during the fastening process.

2. A fastening arrangement according to claim 1 for a pressure sensor (2) serving as the sensor device on the receptacle (1) with
a pressure sensor housing (2) serving as the sensor housing, which receives the pressure sensor device (28) serving as sensor device and which exhibits an at least partially circumferential housing stop (27),
a fastening device (14) on the receptacle (1), which fastening device (14) exhibits a through-hole (13, 13a) serving as receptacle through-hole to the interior (12) of the receptacle (1) and exhibits the receptacle stop (16), as well as a thread (15) for securing the housing (20, 23) to the fastening device (14), and
a fastening means (4) for securing the housing stop (27) to the receptacle stop (16),
wherein
the thread (15) takes the form of an inner thread (15) in the receptacle through-hole (13, 13a), and
the fastening means takes the form of the pressure screw (4) exhibiting an outer thread (42) for engaging with the inner thread (15) and exhibiting a pressure screw through-hole (41) running in the axial direction for at least partial reception of the housing (20, 23) and exhibiting a pressure area (43) on its front end for pressing the housing stop (27) against the receptacle stop (16) to establish a secure connection.

3. A fastening arrangement according to claim 2, in which the inner thread (15) is designed for a screw engagement with the pressure screw (4) in an outwardly directed section of the receptacle through-hole (13) or the bushing through-hole (13a).

4. A fastening arrangement according to claim 1, in which the receptacle stop (16) is designed as a bushing in the receptacle (1).

5. A fastening arrangement according to claim 1, in which the pressure screw (4) exhibits the central axial pressure screw through-hole (41) such that the pressure screw (4) rotates around the housing (20, 23) when the sensor (2, 20, 23) is secured to the receptacle (1).

6. A fastening arrangement according to claim 5, in which the housing (20, 23) is sealed with a circumferential seal (24) vis-a-vis the receptacle through-hole (13, 13a), where for the purpose of screwing the pressure screw (4) is designed for easily-rotating, axial insertion of the housing (20, 23) into the receptacle through-hole (13).

7. A fastening arrangement according to claim 1, in which the housing stop (27) protrudes from the outside of the housing (20, 23) and exhibits a housing stop area (27a) pointing in the direction of the receptacle (1) in order to limit the insertion depth of the housing (20, 23) into the receptacle through-hole (13, 13a) through abutment with the receptacle stop (16).

8. A fastening arrangement according to claim 1, in which the receptacle stop (16) is located inside the receptacle through-hole (13) or the bushing through-hole (13a).

9. A fastening arrangement according to claim 1, in which the housing stop (27) and/or another housing stop which projects laterally from the housing (20, 23) exhibits a stop area that faces away from the receptacle (1) and serves as a counter-stop for the pressure area (43) of the pressure screw (4).

10. A fastening arrangement according to claim 1, in which the sensor device (28) is a pressure sensor with an outer diameter of less than 115 mm, particularly less than or equal to 30 mm.

11. A fastening arrangement according to claim 1, in which the housing (20, 23) in its section that is to be inserted into the receptacle through-hole (13, 13a) exhibits an outer diameter that is less than 115 mm, particularly less than or equal to 30 mm.

12. A fastening arrangement according to claim 1, in which the housing (20, 21) has an external housing stop (5) which projects outward from the housing (20, 21) in a section that is located on the side of the pressure screw (4) that faces away from the receptacle (1).
